(19) United States
(12) Patent Application Publication
(10) Pub. No.: US 2012/0024027 A1
(43) Pub. Date: Feb. 2, 2012

(54) WATER PURIFICATION MATERIAL, WATER PURIFICATION METHOD, PHOSPHATE FERTILIZER PRECURSOR, AND METHOD FOR MANUFACTURING A PHOSPHATE FERTILIZER PRECURSOR

(76) Inventors: Hideyuki TSUJI, Yokohama-shi (JP); Tatsuoki Kohno, Tokyo (JP); Akiko Suzuki, Tokyo (JP); Shinji Murai, Sagamihara-shi (JP); Katsuya Yamamoto, Kawasaki-shi (JP); Nobuyuki Ashikaga, Kawasaki-shi (JP)

(21) Appl. No.: 13/209,768

(22) Filed: Aug. 15, 2011

Related U.S. Application Data
(63) Continuation of application No. PCT/JP2010/003550, filed on May 27, 2010.

(30) Foreign Application Priority Data
May 29, 2009 (JP) P2009-130044

(51) Int. Cl. C05B 17/00; C02F 5/08; C02F 1/42

(52) U.S. Cl. 71/48; 210/683; 252/175; 71/33

(57) ABSTRACT

There is provided a water purification material including: a composite metal hydroxide exhibiting a layered structure and including iron ions, calcium ions, and at least one of nitrogen ions and sulfur ions; and at least one of calcium hydroxide and ferric hydroxide, in which a main peak intensity due to at least one of the calcium hydroxide and the ferric hydroxide measured by x-ray crystal structure analysis is equal to or less than half a main peak intensity due to the layered structure of the composite metal hydroxide.

### CROSS-REFERENCE TO RELATED APPLICATIONS

This application is a continuation of prior International Application No. PCT/JP2010/003550, filed on May 27, 2010 which is based upon and claims the benefit of priority from Japanese Patent Application No. 2009-130044, filed on May 29, 2009; the entire contents of all of which are incorporated herein by reference.

### FIELD

Embodiments described herein relates generally to a water purification material and a water purification method capable of selectively absorbing phosphorus compounds such as phosphate ions contained in water of river or lake, sewage, industrial wastewater, and so on, and further to a phosphate fertilizer precursor and a method for manufacturing a phosphate fertilizer precursor, which are techniques to reuse a water purification material after absorbing phosphorus compounds.

### BACKGROUND

In recent years, due to rapid globalization of economic activities, world-scale environmental contamination and water contamination are becoming serious problems. Further, world-scale production activities lead to resource depletion at the same time, and there is a tendency for kinds of elements recognized as rare elements to increase. Recently, decrease of phosphate rock on a world scale is in progress, and phosphorus is being recognized as a rare element in recent years.

On the other hand, conventionally there have been made strict emission standards for phosphorus as a measure for eutrophication problems in a closed water area such as a lake or gulf. As means for removing phosphorus (actually in the form of phosphate ions) from water, a method to add a calcium compound or the like as a flocculating agent to form phosphates, and thereafter allow the phosphates to flocculate and precipitate, and the like are widely known. However, generally phosphates are floating materials that do not precipitate easily, and thus for allowing phosphates to quickly precipitate, formation of flocs is necessary, which results in formation of a large amount of sludge.

Consequently, there has been a problem that the load in terms of costs increases because increase in scale of treatment equipment is inevitably required for treating a large amount of sludge. Moreover, various types of ion components are taken into flocs by using the flocculating agent, and thus it is also costly to separate these components from the sludge. Due to such reasons, there is also a problem that the sludge is often disposed through a commercial service as industrial waste without being reused.

That is, when phosphorus in water is removed by the conventional method for example, it can be said that flocculation and precipitation by adding a calcium salt have various inefficiency problems of long treatment time, increase in scale of equipment, necessity of sludge treatment, and so on.

In view of such problems, in recent years, many new materials are proposed for water purification. For example, with respect to removal of phosphorus, an absorbing agent having a hydrotalcite structure is proposed as a high performance phosphorus removing agent. The hydrotalcite is a kind of mineral, layered inorganic compound having a mechanism to remove phosphorus (phosphate ions) in water by ion-exchange between anions contained in layers and phosphate ions, and has been reported as having high phosphorus removing performance.

On the other hand, when the absorbing agent is treated as industrial waste, the absorbing agent after absorbing phosphorus eventually needs extra costs and has no advantage compared to the above-described technique, and thus the recycling of the agent is an essential requirement. This recycling needs to separate the absorbed substance, in this case, phosphorus from the absorbing agent. The absorbing agent after the separation of phosphorus can be used again for the absorption and removal of phosphorus as described above. Further, the separated phosphorus itself can be reused as a compound fertilizer by mixing with, for example, other chemical components, or the like.

However, for using the separated phosphorous as a compound fertilizer, various processes such as mixing with chemical components are necessary, resulting in increase of manufacturing cost as a fertilizer. Accordingly, an attempt to reuse phosphorus recovered by an absorbing agent as a fertilizer consequently raises distributed fertilizer prices, eventually hindering reuse of recovered phosphorus as a fertilizer.

### DETAILED DESCRIPTION

One aspect of the present invention relates to a water purification material including: a composite metal hydroxide exhibiting a layered structure and including iron ions, calcium ions, and at least one of nitrogen ions and sulfur ions; and at least one of calcium hydroxide and ferric hydroxide, in which a main peak intensity due to at least one of the calcium hydroxide and the ferric hydroxide measured by x-ray crystal structure analysis is equal to or less than half a main peak intensity due to the layered structure of the composite metal hydroxide.

Hereinafter, details of the present invention and other features and advantages will be described based on an embodiment.

(Water Purification Material)

The water purification material in this embodiment includes a composite metal hydroxide exhibiting a layered structure and including iron ions, calcium ions, and at least one of nitrogen ions and sulfur ions.

The composite metal hydroxide exhibits a layered structure, more specifically, has a structure in which a plurality of layers are made, in which octahedrons each having a calcium ion and an iron ion at its center are two-dimensionally linked. In addition, the calcium ion and the iron ion are located in the same crystal site in the above-described structure, and are in a relation of substituting each other. Further, in such a state, the composite metal hydroxide bears a positive charge, and thus anions forming the composite metal hydroxide intervene between the layers, maintaining the charge neutrality as a whole.

The composition of the composite metal hydroxide are not particularly limited as long as the object of the present invention can be achieved, but may be ones represented by, for example, a general formula: [Ca²⁺₁₋ₓFe³⁺ₓ(OH)ₘ](SO₄²⁻_{y}NO₃⁻_{1-2y})ₓ (0.16≦x≦0.28, 0≦y<0.5, 1.6<m<2.3). In this case, as described above, in the composite metal hydroxide, a plurality of layers are made, in which octahedrons each having a calcium ion (Ca²⁺) and an iron ion (Fe³⁺) at its center are two-dimensionally linked, and sulfate ions (SO₄²⁻) and nitrate ions (NO₃³⁻) intervene between the layers, maintaining the charge neutrality.

In addition, by the composite metal hydroxide having the composition as described above, the following advantages are achieved. That is, the chemical compound represented by the general formula [Ca²⁺₁₋ₓFe³⁺ₓ(OH)ₘ](SO₄²⁻_{y}NO₃⁻_{1-2y})ₓ (0.16≦x≦0.28, 0≦y<0.5, 1.6<m<2.3) has a so-called hydrotalcite structure.

The hydrotalcite is represented by, for example, a general formula [Mg₃Al(OH)₈]½CO₃²⁻·2H₂O, in which octahedrons each having a magnesium ion at its center (blue sight layer) are two-dimensionally linked, and the layers in which magnesium ions are partially substituted with aluminum ions form a layered structure. Carbonate ions and crystal water exist between these layers. The hydrotalcite having such a structure is known to have a property such that the anions between the layers are exchanged with other anions.

Therefore, the composite metal hydroxide in this embodiment having the composition represented by the above-described general formula and exhibiting the hydrotalcite structure enables the exchange of the sulfate ions (SO₄²⁻) and the nitrate ions (NO₃³⁻) which are anions in the general formula with the phosphate ions (anions) contained in wastewater. As a result, phosphate ions or phosphorus in wastewater can be absorbed and recovered effectively.

In the above-described general formula in the present invention, the range of 0.16≦x≦0.28 is desirable. When x is smaller than 0.16, a precipitation characteristic after absorption decreases, and recover of the composite metal hydroxide gradually becomes difficult as x decreases. On the other hand, when x is larger than 0.28, the adsorption amount of phosphorus decreases remarkably. It was found by experiment that high phosphor absorbing performance and an excellent precipitation characteristic after absorption of phosphorus are both achieved when x is in the range of 0.16≦x≦0.28 in the above-described general formula. Further, when x is in this range, it was found as a result of chemical composition analysis that m is in the range of 1.6<m<2.3.

Further, the composite metal hydroxide need not necessarily be represented by the above-described general formula. However, in the case of a constituent exhibiting the hydrotalcite structure, when it is used as a water purification material, it is undesirable that anions which are inappropriate, that is, have adverse effects for the waste water are released in the wastewater by ion exchange. Thus, it is preferred to have composition having anions which are friendly to environment, for example carbonate ions, halogen ions, and the like.

The water purification material in this embodiment has a layered hydroxide structure as a base structure, and adopts a structure having a plurality of layers in which octahedral hydroxides each having a calcium ion and an iron ion at its center are two-dimensionally linked as described above. It can be said that this point is similar to a layered hydroxide such as the hydrotalcite which has been conventionally known.

However, a difference of the water purification material in this embodiment from conventional hydrotalcite-like compounds is that the octahedral hydroxide itself in this embodiment is largely involved in absorption, whereas in a conventional layered hydroxide ion exchange between layers is the main principle of absorption, and the octahedral hydroxide itself is barely involved in absorption.

Therefore, in this embodiment, it is important that the layers in which hydroxides with calcium ions and iron ions are two-dimensionally linked adopt a layered structure. By constructing this layered structure, an excellent absorption amount of phosphorus and precipitation characteristic are achieved.

In this embodiment, it can be said that a dominant cause of the advantage is the formation of the layered structure, but on the other hand, the layered structure formed of hydroxides with calcium ions and iron ions also has an aspect that its crystallinity is not always good.

Accordingly, the surface of the composite metal hydroxide adopting the layered structure may be in a state such that at least one of calcium hydroxide and ferric hydroxide exist partially. Such calcium hydroxide and ferric hydroxide are generally formed at the surface of the above-described composite metal hydroxide. This is because the calcium ions and iron ions existing at the surface of the composite metal hydroxide chemically react with hydroxyl group existing likewise at the surface of the composite metal hydroxide and then become calcium hydroxide and ferric hydroxide.

In the water purification material in this embodiment, the calcium hydroxide and the ferric hydroxide existing at the surface can increase the phosphorus absorption performance and the precipitation characteristic when they are of a certain amount. However, when the amounts of the calcium hydroxide and the ferric hydroxide at the surface of the composite metal hydroxide become too large, ferric phosphates or calcium phosphates may be formed and then become floating matters when phosphate ions are absorbed, significantly deteriorating the precipitation characteristic. Therefore, the calcium hydroxide and the ferric hydroxide existing at the surface of the composite metal hydroxide are preferred to be smaller than a certain amount.

Here, it is conceivable that the improvement in phosphorus absorption performance due to the existence of the calcium hydroxide and the ferric hydroxide at the surface of the water purification material in this embodiment is due to, in principle, these hydroxides directly absorb phosphorus by ligand exchange reaction with phosphate ions in water.

The amounts of the calcium hydroxide and the ferric hydroxide can be identified as calcium ions and iron ions by X-ray crystal structure analysis. Specifically, in the X-ray crystal structure analysis, a main peak intensity due to calcium ions and iron ions existing at the surface of the composite metal hydroxide is preferred to be equal to or less than half a main peak intensity due to the layered structure of the composite metal hydroxide.

As a result, the water purification material of this embodiment can absorb phosphate ions both at the surface and inside (between the layers of the layered structure), and thus a relatively large amount of phosphorus (phosphate ions) in wastewater can be absorbed and recovered with high efficiency.

Further, the water purification material of this embodiment has a high absorbing characteristic with respect particularly to phosphate ions as described above, and is able to selectively absorb phosphate ions. Such high absorbing characteristic and high selectivity with respect to phosphate ions are characteristic properties which are not seen in publicly known hydrotalcites.

When both the calcium hydroxide and the ferric hydroxide exist at the surface of the composite metal hydroxide, the sum of the main peak intensities due to calcium ions and iron ions are preferred to be equal to or less than half the main peak intensity due to the layered structure. When one of the hydroxides exists, the main peak intensity of one of the ions may be or less than half the main peak intensity due to the layered structure.

Here, since the excellent phosphorus absorption performance and the excellent precipitation characteristic of the water purification material in this embodiment are, as described above, fundamentally originated from the layered structure formed of hydroxides having calcium ions and iron ions, and thus the calcium hydroxide and the ferric hydroxide existing at the surface of the composite metal hydroxide are not always necessary. However, further improvement in performance is achieved by including them in a certain range.

Further, as can be inferred from the above-described absorption principle, it can be said that the main peak intensity due to calcium ions and iron ions existing at the surface of the composite metal hydroxide contributes to improvement in performance even when it is very weak. Therefore, as long as the sum of the main peak intensities due to calcium ions and iron ions existing at the surface of the composite metal hydroxide are equal to or less than half the main peak intensity due to the layered structure, the range thereof is not particularly limited.

In this embodiment, another metal (hereinafter referred to as third metal) may be contained in a range that would not impair the operation and effect of the present invention. As this third metal, other than those contained inevitably in the manufacturing process, magnesium or the like formed by replacing part of calcium can be exemplified in view of controlling the crystallinity having a close relation with the precipitation characteristic. However, the content of the third metal is preferred to be 10 mol % or less with respect to the total metal elements contained in the composite metal hydroxide.

The water purification material in this embodiment contains the composite metal hydroxide as described above, but the composite metal hydroxide may be used as it is, for example, in a powder form. Further, the composite metal hydroxide may be shaped into various forms as necessary and used. Alternatively, the mixing with a binder to granulate, the carrying in an organic or inorganic film to be in a film form, the making a structure filled in a column, or the like is also possible. Further, if necessary in the case of granulating, a method of producing a porous body which has been conventionally known, such as incorporating a binder and then burning it, may be applied.

### (Method for Manufacturing the Water Purification Material)

Next, a method for manufacturing the above-described water purification material will be described. The water purification material can be manufactured basically by subjecting a chemical compound containing calcium and a chemical compound containing iron to hydrothermal reaction. The chemical compounds which can be used here as raw materials are not particularly limited, and chloride, carbonate, nitrate, sulfate, or the like of calcium or iron may be used for example. At this time, the pH of a reaction solution is preferred to be alkaline. Besides performing under normal pressure, such reaction may be performed under high pressure using an autoclave or the like.

The reaction condition is selected according to the structure, particle diameter, and so on of the target composite metal hydroxide, and generally subjected to reaction at the temperature range of 25° C. to 200° C., preferably at 60° C. to 95° C. The pressure may be set to a normal pressure, or compression pressure or decompression pressure, for example, within a range of 0.01 MPa to 2.0 MPa may be performed using an autoclave or the like.

### (Usage of the Water Purification Material)

Usage of the water purification material in this embodiment, that is, water purification method using the water purification material will be described.

The water purification method in this embodiment is quite simple, and is implemented by just bringing the water purification material obtained as described above into contact with wastewater. Thus, the anions in the layers of the water purification material are exchanged with phosphate ions. Moreover, the calcium hydroxide and the ferric hydroxide formed at the surface of the composite metal hydroxide causes some kinds of chemical interactions with the phosphate ions in the wastewater. As a result, the phosphate ions in the wastewater are absorbed into the surface of the composite metal hydroxide due to the hydroxyl group, calcium ions, and so on, and can be recovered.

In addition, when the composite metal hydroxide has the composition as represented by the above-described general formula and exhibits the hydrotalcite structure, the anions in the general formula, the sulfate ions (SO₄²⁻) and the nitrate ions (NO₃³⁻) are exchanged with the phosphate ions (anions) contained in wastewater, so as to absorb and recover the phosphate ions or phosphorus in the wastewater.

As a specific method to bring the water purification material into contact with wastewater, for example, there is one including dropping powder of the water purification material or granulated powder using a binder into wastewater, stirring the wastewater as necessary to allow absorption of anions, and allowing precipitation. This method is effective when treating a relatively large amount of wastewater. By this method, there is a concern that the water purification equipment becomes relatively large, but there is also an advantage that a large amount of wastewater can be treated at once.

Further, phosphate ions or phosphorus can be recovered by making a film carrying the water purification material, specifically, the composite metal hydroxide itself, and dipping this film in the wastewater. Moreover, phosphate ions or phosphorus can also be recovered by filling the composite metal hydroxide or granulated powder or the like in a column, and introducing wastewater into this column to allow contacting. These methods use a relatively small treatment apparatus but have a limited wastewater treatment capacity, and hence are preferable for treating a small amount of wastewater.

Note that the water purification material in this embodiment can be applied to wastewater with any pH. However, the water purification material may be dissolved in strong acid. Therefore, the range of pH preferred when applying the water purification method according to the present invention is pH 2.0 to pH 14.0, more preferably, pH 3.0 to pH 13.0.

### EXAMPLES

### Example 1

Calcium nitrate and iron nitrate (III) were mixed in pure water so as to have a Ca/Fe mole ratio of 5.25, and solved in a NaOH solution while adjusting the solution to be alkaline, thereby obtaining a solution of 200 mL. Next, the solution was kept at 80° C. to 100° C. for few hours to produce a precipitate. Finally, the produced precipitate was filtered out and cleaned, and dried at 90° C. to 100° C. for few hours to make a sample 1. By ICP emission spectroscopy and ion chromatography, it was confirmed that the sample 1 is a composite metal hydroxide of calcium and iron, and can be represented by a general formula [Ca_{0.84}Fe_{0.16}(OH)ₘ](NO₃⁻)_{0.16}. Further, by X-ray diffractometry, it was confirmed that this composite metal hydroxide has a layered structure.

On the other hand, a mixed aqueous solution adjusted so that each of phosphate ion concentration, sulfate ion concentration, and chlorine ion concentration is 100 mg/L was prepared as a simulating wastewater. The sample 1 of 50 mg was dropped into this solution simulating wastewater 50 of mL, and mixed and stirred for two hours, thereby performing water purification treatment. After the treatment, the sample and supernatant liquid were separated by filtering, each ion concentration in the supernatant liquid was quantitatively analyzed, and the residual ratios of the respective ions and the phosphorus absorption amount were calculated. Further, the time taken for the filtering was measured so as to evaluate the precipitation characteristic and the dehydration characteristic.

Further, citric acid solubility of the sample after absorbing phosphorus was evaluated. The citric acid solubility is a characteristic required in a phosphate fertilizer, and refers to the ratio of phosphorus which elutes when it is dipped in a 2 wt % citric acid solution at a liquid temperature of 30° C. The phosphate fertilizer is required to have high citric acid solubility, and thus the ratio of phosphorus to be eluted by citric acid is preferred to be as high as possible. Evaluation of the citric acid solubility was performed by dipping a sample, which absorbed phosphorus in a water purification treatment test, in a citric acid solution, and calculating the ratio of the eluted phosphorus. Results obtained about them are as illustrated in Table 1.

### Example 2

Sample 2 was obtained by the same method as in Example 1 except that the calcium nitrate and the iron nitrate (III) as raw materials were adjusted so as to have a Ca/Fe mole ratio of 4.9. By the same methods as in Example 1, it was confirmed that the sample 2 is a composite metal hydroxide which can be represented by a general formula [Ca_{0.83}Fe_{0.17}(OH)ₘ](NO₃⁻)_{0.17} and has a layered structure. Using this sample 2, water purification treatment was performed by the same method as in Example 1. Obtained results are as illustrated in Table 1.

### Example 3

Sample 3 was obtained by the same method as in Example 1 except that the calcium nitrate and calcium sulfate and iron nitrate (III) and calcium sulfate (III) as raw materials were adjusted so as to have a Ca/Fe mole ratio of 4.6. By the same methods as in Example 1, it was confirmed that the sample 3 is a composite metal hydroxide which can be represented by a general formula [Ca_{0.82}Fe_{0.18}(OH)ₘ](SO₄²⁻_{0.2}NO₃⁻_{0.6})_{0.18} and has a layered structure. Using this sample 3, water purification treatment was performed by the same method as in Example 1. Obtained results are as illustrated in Table 1.

### Example 4

Sample 4 was obtained by the same method as in Example 1 except that the calcium nitrate and the iron nitrate (III) as raw materials were adjusted so as to have a Ca/Fe mole ratio of 4.0. By the same methods as in Example 1, it was confirmed that the sample 4 is a composite metal hydroxide which can be represented by a general formula [Ca_{0.80}Fe_{0.20}(OH)ₘ](NO₃⁻)_{0.20} and has a layered structure. Using this sample 4, water purification treatment was performed by the same method as in Example 1. Obtained results are as illustrated in Table 1.

### Example 5

Sample 5 was obtained by the same method as in Example 1 except that the calcium nitrate and the iron nitrate (III) as raw materials were adjusted so as to have a Ca/Fe mole ratio of 3.0. By the same methods as in Example 1, it was confirmed that the sample 5 is a composite metal hydroxide which can be represented by a general formula [Ca_{0.75}Fe_{0.25}(OH)ₘ](NO₃⁻)_{0.25} and has a layered structure. Using this sample 5, water purification treatment was performed by the same method as in Example 1. Obtained results are as illustrated in Table 1.

### Example 6

Sample 6 was obtained by the same method as in Example 1 except that the calcium nitrate and calcium sulfate and iron nitrate (III) and calcium sulfate (III) as raw materials were adjusted so as to have a Ca/Fe mole ratio of 2.9. By the same methods as in Example 1, it was confirmed that the sample 6 is a composite metal hydroxide which can be represented by a general formula [Ca_{0.74}Fe_{0.26}(OH)ₘ](SO4²⁻_{0.25}NO₃⁻_{0.5})_{0.26} and has a layered structure. Using this sample 6, water purification treatment was performed by the same method as in Example 1. Obtained results are as illustrated in Table 1.

### Example 7

Sample 7 was obtained by the same method as in Example 1 except that the calcium nitrate and the iron nitrate (III) as raw materials were adjusted so as to have a Ca/Fe mole ratio of 2.6. By the same methods as in Example 1, it was confirmed that the sample 7 is a composite metal hydroxide which can be represented by a general formula [Ca_{0.72}Fe_{0.28}(OH)ₘ](NO₃⁻)_{0.28} and has a layered structure. Using this sample 7, water purification treatment was performed by the same method as in Example 1. Obtained results are as illustrated in Table 1.

### Comparative Example 1

Magnesium chloride and aluminum chloride are mixed in pure water so as to have a Mg/Al ratio of 3.0, and solved in a NaOH solution while adjusting the solution to be alkaline, thereby obtaining a solution of 200 mL. Next, the solution was kept at 80° C. to 100° C. for few hours to produce a precipitate. Finally, the produced precipitate was filtered out and cleaned, and dried at 90° C. to 100° C. for few hours to make a sample 8. This sample 8 is formed of a hydrotalcite containing magnesium and aluminum. Using this sample 8, water purification treatment was performed by the same method as in Example 1. Obtained results are as illustrated in Table 1.

### Comparative Example 2

Sample 9 was obtained by the same method as in Example 1 except that the magnesium chloride and the aluminum chloride as raw materials were adjusted so as to have a Mg/Al ratio of 2.0. The sample 9 is formed of a hydrotalcite containing magnesium and aluminum. Using this sample 9, water purification treatment was performed by the same method as in Example 1. Obtained results are as illustrated in Table 1.

### Comparative Example 3

Sample 10 was obtained by the same method as in Example 1 except that the calcium nitrate and the iron nitrate (III) as raw materials were adjusted so as to have a Ca/Fe mole ratio of 6.0. By the same methods as in Example 1, it was confirmed that the sample 10 is a composite metal hydroxide which can be represented by a general formula [Ca_{0.86}Fe_{0.14}(OH)₂] and slightly has a layered structure. However, in analysis by X-ray diffraction, the peak due to calcium hydroxide is more than half the peak due to the layered structure. Using this sample 10, water purification treatment was performed by the same method as in Example 1. Obtained results are as illustrated in Table 1.

### Comparative Example 4

Sample 11 was obtained by the same method as in Example 1 except that the calcium nitrate and the iron nitrate (III) as raw materials were adjusted so as to have a Ca/Fe mole ratio of 2.3. By the same methods as in Example 1, it was confirmed that the sample 11 is a composite metal hydroxide which can be represented by a general formula [Ca_{0.69}Fe_{0.31}(OH)₂] and slightly has a layered structure. However, in analysis by X-ray diffraction, each of peaks due to calcium hydroxide and ferric hydroxide is more than half the peak due to the layered structure. Using this sample 11, water purification treatment was performed by the same method as in Example 1. Obtained results are as illustrated in Table 1.

TABLE 1

| | | | | Sulfate | Chlorine | Phosphorus | | |
|---|---|---|---|---|---|---|---|---|
| | | | Phosphor | Ion | Ion | Absorption | | Raio |
| | | | Residual | Residual | Residual | Amount | Filtration | of |
| | | R | Ratio | Ratio | Ratio | [mg-P/g- | Speed | Phosphorus |
| | | [%] | [%] | [%] | [%] | sample] | [sec] | [%] |
| E1 | S1 | 44 | 7.5 | 94.2 | 96.5 | 92.5 | 55 | 99.9 |
| E2 | S2 | 39 | 10.1 | 95.3 | 97.0 | 89.9 | 51 | 98.7 |
| E3 | S3 | 24 | 12.7 | 96.2 | 95.1 | 87.3 | 49 | 99.5 |
| E4 | S4 | 14 | 14.9 | 92.3 | 96.6 | 85.1 | 53 | 100.0 |
| E5 | S5 | 16 | 17.1 | 94.0 | 95.0 | 82.9 | 55 | 99.1 |
| E6 | S6 | 25 | 16.6 | 94.4 | 96.2 | 83.4 | 44 | 98.3 |
| E7 | S7 | 39 | 18.0 | 93.9 | 96.9 | 82.0 | 41 | 99.8 |
| CE1 | S8 | — | 75.7 | 50.0 | 100.0 | 24.3 | 44 | 77.1 |
| CE2 | S9 | — | 73.9 | 42.4 | 100.0 | 26.1 | 45 | 67.4 |
| CE3 | S10 | 64 | 13.4 | 92.0 | 93.4 | 86.6 | 1984 | 16.3 |
| CE4 | S11 | 57 | 26.6 | 96.1 | 95.5 | 73.4 | 1630 | 5.8 |

E1 to E7 = Example 1 to Example 7;
CE1 to CE4 = Comparative Example 1 to Comparative Example 4;
S1 to S11 = Sample 1 to Sample 11

In table 1, there are illustrated the ratios R between the peak intensity of each of calcium hydroxide and ferric hydroxide and the peak intensity due to the layered structure which are calculated from an X-ray diffraction pattern [R=(main peak intensity due to calcium hydroxide+main peak intensity due to ferric hydroxide)/(main peak intensity due to the layered structure)×100(%)], the concentrations of ionic species in the simulating wastewater after test, and the phosphorus absorption amounts in respective samples. Further, the filtration times needed for solid-liquid separation after test and the results of citric acid solubility evaluation tests are also illustrated.

Examples 1 to 7 in accordance with the present invention all resulted in that the phosphorus absorption amount is 80 [mg−P/g−sample], and the absorption amounts of sulfate ions and chlorine ions are low. That is, they absorb phosphorus quite efficiently. Further, the times taken for filtration are short, from which it was found that they have no problem when being handled in practice. Moreover, it was found that the absorbed phosphorus is mostly in the form of citric acid solubility, and sufficient effectiveness as fertilizer can be expected when it is used as fertilizer as it is after being absorbed.

On the other hand, in Comparative Examples 1 and 2, the performance as an absorbing agent is not sufficient such that the phosphorus absorption amounts are not sufficient, and the selectivity to sulfate ions is high. The citric acid solubility is not sufficient either. In Comparative Examples 3 and 4, the phosphate ion concentrations decrease, but it takes a long time for filtering caused by the formation of flocs due to ferric hydroxide and calcium hydroxide, and thus it was found that these examples have difficulties in practice. Further, these examples also resulted in low citric acid solubility.

From these results, it can be said that the water purification material based on the present invention has high phosphorus absorption performance and dehydration characteristic (filtration characteristic), is clearly different from conventional materials in that it further has a characteristic of high citric acid solubility, and is a quite excellent absorbing agent in view of conversion into fertilizer after absorbing phosphorus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A water purification material, comprising:
a composite metal hydroxide exhibiting a layered structure and including iron ions, calcium ions, and at least one of nitrogen ions and sulfur ions; and
at least one of calcium hydroxide and ferric hydroxide,
wherein a main peak intensity due to at least one of the calcium hydroxide and the ferric hydroxide measured by x-ray crystal structure analysis is equal to or less than half a main peak intensity due to the layered structure of the composite metal hydroxide.

2. The water purification material according to claim 1,
wherein the composite metal hydroxide is represented as a general formula: [Ca²⁺₁₋ₓFe³⁺ₓ(OH)ₘ](SO₄²⁻_{y}NO₃⁻_{1-2y})ₓ (0.16≦x≦0.28, 0≦y<0.5, 1.6<m<2.3).

3. The water purification material according to claim 1, wherein the composite metal hydroxide exhibits a hydrotalcite structure.

4. The water purification material according to claim 1, wherein at least one of the calcium hydroxide and the ferric hydroxide is formed in at least a surface of the composite metal hydroxide.

5. A water purification method, comprising:
bringing the water purification material according to claim 1 into contact with wastewater to allow the water purification material to absorb phosphorus-containing substances in the wastewater.

6. A phosphate fertilizer precursor, comprising:
the water purification material according to claim 1; and
a phosphorus containing compound absorbed into the water purification material.

7. A method for manufacturing a phosphate fertilizer precursor, comprising:
bringing the water purification material according to claim 1 into contact with wastewater to allow the water purification material to absorb phosphorus-containing substances in the wastewater, so as to produce a phosphate fertilizer precursor comprising the water purification material and a phosphorus containing compound absorbed into the water purification material.
